(19) United States
(12) Patent Application Publication
(10) Pub. No.: US 2022/0153325 A1
(43) Pub. Date: May 19, 2022

(54) WIRELESS VEHICLE CONTROL SYSTEM

(71) Applicant: Transportation IP Holdings, LLC, Norwalk, CT (US)

(72) Inventors: Mauricio Bernes, Fort Worth, TX (US); Adam Hausmann, Melbourne, FL (US); Sergio Brutman, Fort Worth, TX (US); Victor Perez, Guadalajara (MX); Daniel Rush, Saint Charles, IL (US); Steve Seip, Erie, PA (US); Maurice Hutchins, Mims, FL (US)

(21) Appl. No.: 17/503,045

(22) Filed: Oct. 15, 2021

Related U.S. Application Data
(60) Provisional application No. 63/114,225, filed on Nov. 16, 2020.

(51) Int. Cl. B61L 15/00; B61L 27/00

(52) U.S. Cl. CPC B61L 15/0027; B61L 2205/00; B61L 27/0005

(57) ABSTRACT

A vehicle control system includes a controller configured to be operably deployed onboard a first propulsion-generating vehicle of a multi-vehicle system, and a wireless communication unit configured to be electrically coupled to the controller. The controller is configured to control the wireless communication unit to wirelessly communicate first vehicle control signals to a second propulsion-generating vehicle of the multi-vehicle system that is immediately adjacent and mechanically coupled to the first propulsion-generating vehicle, while the first propulsion-generating vehicle and the second propulsion-generating vehicle are in a non-cable-connected state. The controller also is configured to control the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system.

### CROSS-REFERENCE TO RELATED APPLICATIONS

This application claims priority to U.S. Provisional Application No. 63/114,225 (filed 16 Nov. 2020), the entire disclosure of which is incorporated herein by reference.

### BACKGROUND

### Technical Field

The inventive subject matter described herein relates to wireless control of propulsion-generating vehicles in a multi-vehicle system.

### Discussion of Art

Some known vehicle systems can include several propulsion-generating vehicles that are coupled with each other to push and/or pull other vehicles (e.g., non-propulsion-generating vehicles). For example, some rail vehicle systems include several locomotives and rail cars or passenger cars interconnected with each other. Different control or communication schemes can be used to coordinate movements of the propulsion-generating vehicles with each other to ensure that the propulsion and/or braking generated by the different vehicles safely move the vehicle system along a route.

As one example, multiple unit (MU) control can be used to simultaneously control all locomotives that are adjacent to and connected with each other in the same consist. An MU cable can be electrically or conductively coupled with the locomotives in the same consist. Electronic signals from a lead or controlling locomotive in each consist are sent to trail locomotives in the same consist via the MU cable. These signals direct throttle settings and/or dynamic brake settings of the trail locomotives. All locomotives in the same consist can be commanded to operate at the same throttle setting or dynamic brake setting. Additionally, the amount of information communicated via an MU cable is significantly limited, as the cable is a twenty-seven pin cable with most of these pins carrying a binary signal and as few as a single pin carrying an analog signal.

As another example, distributed power (DP) control can be used to control multiple locomotives that are not adjacent to each other. For example, the locomotives can be distributed throughout the length of a vehicle system and are not adjacent to each other. A lead locomotive can send signals via a wireless radio frequency (RF) signal or via a wired path (e.g., a trainline). These signals can direct throttle and/or brake settings of the non-adjacent locomotives.

One problem with MU control is the requirement of the MU cable to communicate signals to the locomotives that are coupled with each other. These cables can be stolen or damaged, thereby preventing use of MU control. Some attempts have been made to use wireless DP to control locomotives when the MU cable is no longer available for communication. But DP control may rely on the locomotives not being adjacent to each other (e.g., coupled with each other with no other locomotive or other vehicle between the adjacent locomotives). Using wireless DP control for adjacent locomotives can prevent the locomotives from cohesively operating together, and can result in unsafe forces being generated between vehicles in the train. A need exists for a system and method that provides for wireless control of propulsion-generating vehicles in a vehicle system that addresses the shortcomings of currently known systems and methods.

### BRIEF DESCRIPTION

In an example, a vehicle control system includes a controller that may be operably deployed onboard a first propulsion-generating vehicle of a multi-vehicle system, and a wireless communication unit that may be electrically coupled to the controller. The controller may control the wireless communication unit to wirelessly communicate first vehicle control signals to a second propulsion-generating vehicle of the multi-vehicle system that is immediately adjacent and mechanically coupled to the first propulsion-generating vehicle, while the first propulsion-generating vehicle and the second propulsion-generating vehicle are in a non-cable-connected state. The controller may control the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system.

In an example, a method includes controlling a wireless communication unit onboard a first propulsion-generating vehicle to wirelessly communicate first vehicle control signals to a second propulsion-generating vehicle of a multi-vehicle system that is immediately adjacent and mechanically coupled to the first propulsion-generating vehicle, while the first propulsion-generating vehicle and the second propulsion-generating vehicle are in a non-cable-connected state. The method also includes controlling the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system.

In an example, a vehicle control system includes at least one processor that may be operably deployed onboard a first propulsion-generating vehicle of a vehicle system, and a wireless communication unit that may be electrically coupled to the at least one processor. The at least one processor may, responsive to first information that the first propulsion-generating vehicle and a second propulsion-generating vehicle that is immediately adjacent and mechanically coupled to the first propulsion-generating vehicle are in a non-cable-connected state, control the wireless communication unit to wirelessly transmit first vehicle control signals in a first bandwidth to the second propulsion-generating vehicle. Responsive to second information that the first propulsion-generating vehicle and the propulsion-generating vehicle are in a cable-connected state, the at least one processor may control communication of the first vehicle control signals to the second propulsion-generating vehicle over a cable. The at least one processor may control the wireless communication unit to wirelessly transmit different, second vehicle control signals in a distinct, second bandwidth to a third propulsion-generating vehicle of the vehicle system that is separated from the first and second propulsion-generating vehicles by at least one non-propulsion-generating vehicle.

### BRIEF DESCRIPTION OF THE DRAWINGS

The inventive subject matter may be understood from reading the following description of non-limiting examples, with reference to the attached drawings, wherein below:

FIG. 1 illustrates one example of a vehicle control system disposed onboard a multi-vehicle system;

FIG. 2 illustrates one example of the control system disposed onboard the vehicles; and

FIG. 3 illustrates a flowchart of one example of a method for controlling movement of a vehicle system.

### DETAILED DESCRIPTION

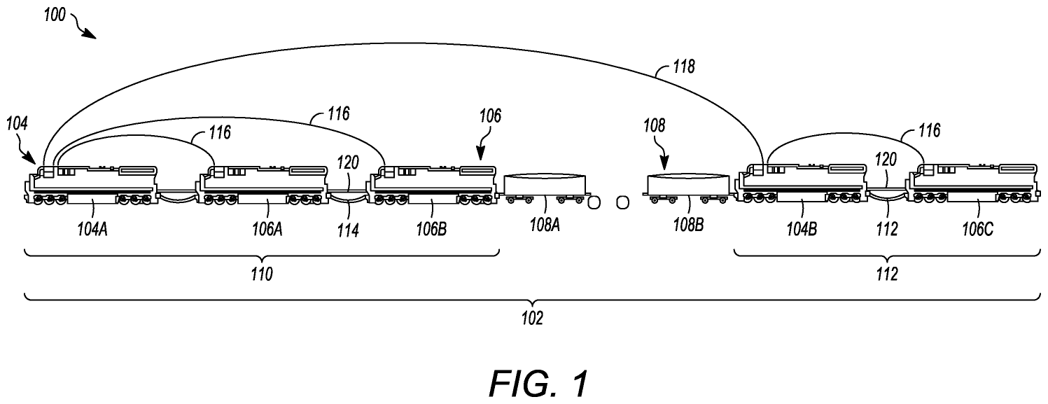

FIG. 1 illustrates one example of a vehicle control system 100 disposed onboard a multi-vehicle system 102. The vehicle system is formed from multiple propulsion-generating vehicles 104, 106 (vehicles 104A-B, 106A-C) and one or more non-propulsion-generating vehicles 108 (vehicles 108A-B). The number and/or arrangement of the vehicles 104, 106, 108 in the vehicle system may differ from what is shown in FIG. 1. In the illustrated example, the propulsion-generating vehicles are locomotives and the non-propulsion-generating vehicles are rail cars, but alternatively, these vehicles may not be rail vehicles. For example, the vehicles may be automobiles, trucks, trailers, mining vehicles, agricultural vehicles, or the like. The adjacent or neighboring vehicles in the vehicle system are mechanically coupled with each other (e.g., by couplers 118). Alternatively, two or more of the vehicles may be logically coupled but not mechanically coupled, such as where the logically coupled vehicles are separate but communicate with each other to coordinate movements (e.g., to travel as a convoy).

The vehicle system includes two consists 110, 112 each formed of different sets of the propulsion-generating vehicles that are directly adjacent to each other (e.g., there is no other vehicle between the directly adjacent vehicles). The first consist 110 includes the vehicles 104A, 106A-B and the second consist 112 includes the vehicles 104B, 106C.

The vehicles 104 are lead or controlling vehicles and the vehicles 106 are trail vehicles. In the first consist, the vehicle 104A can be referred to as the lead vehicle as this vehicle controls or directs the operational settings of the other vehicles 106A-B to control movement of the vehicle system. Each of the vehicles 106A-B in the same first consist as the lead vehicle is referred to as a trail vehicle. The trail vehicles are controlled and operate according to signals received from the lead vehicle. While the lead vehicle is shown at a leading end of the vehicle system and first consist (along a direction of movement of the vehicle system and first consist), the lead vehicle may be in another location in the first consist.

In the second consist, the vehicle 104B can be referred to as a controlling remote vehicle as this vehicle commands the operational settings of the vehicle 106C within the same second consist (but not in the first consist or another consist) based on commands from the lead vehicle in the first consist. The vehicle 106C in the second consist can be referred to as a trail-to-remote vehicle as this vehicle is controlled and operates according to signals received from the controlling remote vehicle.

The propulsion-generating vehicles can operate in a cable-connected state or a non-cable-connected state to coordinate movements of the vehicles. In either state, the lead vehicle issues commands via control signals that are directly or indirectly communicated to the other propulsion-generating-vehicles in the vehicle system. The different states may be associated with different bandwidths for communication. In a cable-connected state, the propulsion-generating vehicles in each consist are conductively coupled with each other by one or more intra-consist cables 114, such as an MU cable. In this state, the vehicles can communicate with each other using electronic signals that are conducted via conductive pathways (e.g., the cables). The cable(s) represent a first bandwidth. For example, a first MU cable 114 may conductively couple the vehicles 104A, 106A, 106B in the first consist and a separate, second MU cable 114 may conductively couple the vehicles 104B, 106C in the second consist. Optionally, several shorter lengths of cables that each connect adjacent vehicles may, in combination, form an intra-consist cable. The lead vehicle can communicate wired control or command signals to the trail vehicles in the first consist via the first intra-consist cable. These wired signals can dictate the throttle settings and/or brake settings (e.g., dynamic brake settings) that the trail vehicles are to implement to control movement of the vehicles in the first consist.

The lead vehicle also can wirelessly communicate control or command signals to the controlling remote vehicle in the second consist. These signals can be referred to as consist control signals and can dictate or direct tractive efforts or braking efforts that the second consist is to produce to coordinate movement of the second consist with the first consist. For example, the lead vehicle can wirelessly send a signal to the controlling remote vehicle that requests the vehicles in the second consist to collectively produce a tractive effort or braking effort. This can help control forces imparted on couplers between the vehicles in the vehicle system (within or between the consists). The controlling remote vehicle can receive this wireless signal and, based on the tractive effort or braking effort that the second consist is directed to produce by the wireless signal, the controlling remote vehicle can determine the operational settings to be implemented by the trail-to-remote vehicles in the second consist. The controlling remote vehicle can then communicate control or command signals to the trail-to-remote vehicles in the second consist via the second intra-consist (e.g., MU) cable. These signals can dictate the throttle settings and/or brake settings (e.g., dynamic brake settings) that the trail-to-remote vehicles are to implement to control movement of the vehicles in the second consist.

In the non-cable-connected state, the vehicles are not conductively coupled with each other by one or more cables or are otherwise unable to communicate with each other using signals that are conducted via conductive pathways (e.g., cables). For example, an MU cable may be disconnected and stolen (while the vehicle system is stationary or moving slow, such as slower than twenty-five kilometers per hour), an MU cable can be damaged or broken, or a device that uses the MU cable to communicate may no longer function). As a result, the lead vehicle may be unable to communicate control signals to the trail vehicles via the first intra-consist cable and/or the controlling remote vehicle may be unable to communicate control signals to the trail-to-remote vehicles via the second intra-consist cable. This can prevent the vehicle system from operating. While the lead vehicle may have onboard components to allow for wireless DP control of other propulsion-generating vehicles, this may not be able to be used for all propulsion-generating vehicles as use of DP control for adjacent propulsion-generating vehicles may cause unsafe operation of the vehicle system (e.g., by generating too large of tensile or compressive forces on couplers).

Additionally, some energy management systems that dictate operational settings of the propulsion-generating vehicles as a function of time, distance, and/or location (e.g., to reduce consumed fuel, generated emissions, generated noise, or the like) can rely on the propulsion-generating vehicles not being directly adjacent to each other. Consequently, when the intra-consist cable is no longer available for communication, the energy management systems may not be able to operate.

In one example of the inventive subject matter described herein, the control system can use wireless communications in the non-cable-connected state to replace the wired communications otherwise provided by the intra-consist cable within at least one of the consists or within each of the consists. For example, the lead vehicle can wirelessly communicate intra-consist control signals 116 to the trail vehicles in the first consist to control the operational settings of the trail vehicles. The intra-consist control signals can dictate the throttle and/or brake settings that the vehicles in the first consist are to implement. The lead vehicle also can wirelessly communicate inter-consist control signals 118 to the controlling remote vehicle. The inter-consist control signal can include information on the total amount of tractive effort and/or braking effort that the entire second consist is to collectively generate. For example, instead of including throttle settings and/or brake settings for each individual propulsion-generating vehicle in the second consist, the inter-consist control signal can indicate the tractive effort and/or braking effort that the second consist is directed to produce, regardless of the throttle settings and/or brake settings of each individual propulsion-generating vehicle in the second consist.

The intra-consist control signal and the inter-consist control signal can be wirelessly communicated by the lead vehicle at the same time. For example, the lead vehicle can wirelessly communicate the intra-consist control signal to the other propulsion-generating vehicle(s) in the same consist as the lead vehicle and can concurrently wirelessly communicate the inter-consist control signal to another consist, such as by communicating the signals within a designated time period of each other (e.g., less than one second apart). In one example, the intra-consist control signals may control the vehicles in an identical manner, while the inter-consist control signals may control other vehicles in a different manner. For example, the propulsion-generating vehicles in a consist that are adjacent to each other and that receive the intra-consist control signals may be controlled to have the same throttle settings, same brake settings, etc., at the same time. But one or more propulsion-generating vehicles that are not in this consist, that are not adjacent to the consist, that are separated from the consist by one or more other vehicles, etc., may be controlled by the inter-consist signals to have a different throttle setting, different brake setting, etc., than the vehicles in the consist at the same time. For example, the intra-consist control signal can direct all propulsion-generating vehicles in the same consist as the vehicle sending the signal to automatically implement the same throttle setting and/or brake setting at the same time (e.g., concurrently). For example, the lead vehicle in the first consist can send an intra-consist control signal to the remote vehicles in the first consist that causes all of the remote vehicles to switch to the same throttle setting or the same brake setting (e.g., as the lead vehicle). In contrast, a DP control signal (described above) can direct different propulsion-generating vehicles (e.g., in the same or different consists) to implement different throttle settings and/or brake settings at the same time.

The wired communication via the intra-consist cables and the wireless communication can represent different and separate bandwidths. For example, the wired communication can be a first bandwidth and the wireless communication can be a separate, second bandwidth. These bandwidths can be separate in that the signals are communicated via, over, or through different media (e.g., conductive material versus electromagnetic waves).

The controlling remote vehicle in the second consist can wirelessly receive the inter-consist control signal and determine intra-consist control signals to be communicated to the other propulsion-generating vehicle(s) in the same consist. For example, the controlling remote vehicle can examine the tractive effort and/or braking effort directed by the inter-consist control signal and determine the throttle settings and/or brake settings of the individual vehicles 104B, 106C in the second consist that are needed to generate the tractive effort and/or braking effort directed by the inter-consist control signal. The controlling remote vehicle can then wirelessly send an intra-consist control signal to the vehicle 104B in the second consist to direct the vehicle 106C to implement the throttle setting and/or brake setting that was determined. The intra-consist signals sent by the lead vehicle in the first consist and by the controlling remote vehicle in the second consist may differ from each other.

In one example, the lead or controlling vehicle in each consist does not wirelessly communicate signals containing throttle settings, brake settings, requested tractive efforts, and/or requested braking efforts to any trail vehicle that is outside of the same consist as the lead or controlling vehicle. For example, the lead vehicle can wirelessly communicate control signals containing throttle settings and/or brake settings to the trail vehicles in the same first consist as the lead vehicle, but does not communicate any such control signal to the trail vehicles in the second consist (i.e., the trail-to-remote vehicles), regardless of whether the signals are transmitted directly to the trail vehicles in the second consist or are relayed to the trail vehicles in the second consist. The controlling vehicle can wirelessly communicate control signals containing throttle settings and/or brake settings to the trail-to-remote vehicles in the same second consist as the controlling vehicle, but does not communicate any such control signal to the trail vehicles in the first consist, regardless of whether the signals are transmitted directly to the trail vehicles in the first consist or are relayed to the trail vehicles in the first consist.

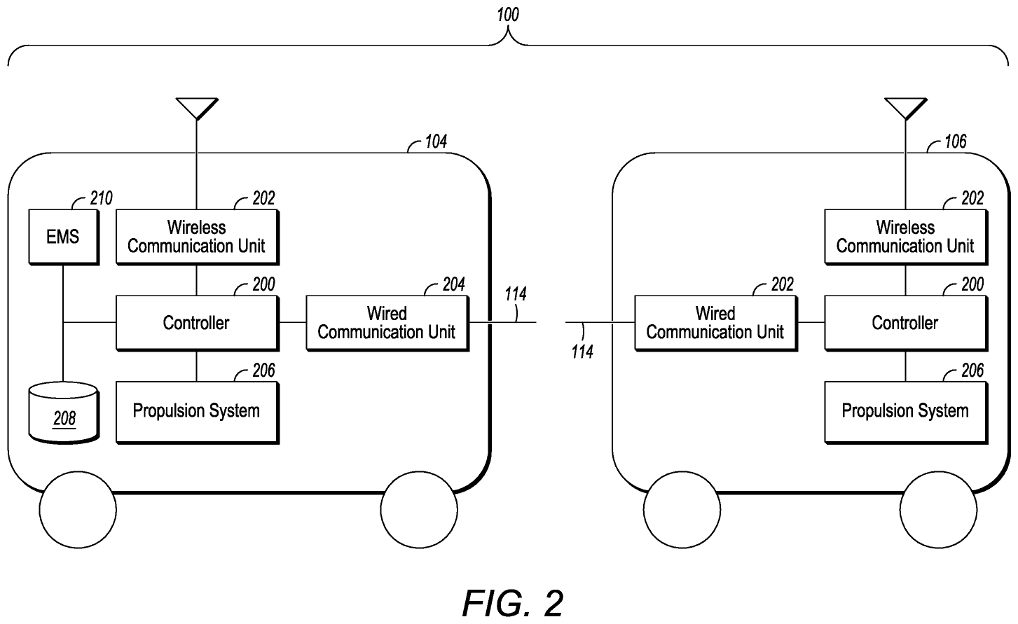

FIG. 2 illustrates one example of the control system 100 disposed onboard the vehicles 104, 106. While the control system is shown onboard two of the propulsion-generating vehicles, components of the control system also may be disposed onboard additional propulsion-generating vehicles. The vehicle 104 in FIG. 2 can represent each of the vehicles 104A, 104B in FIG. 1 and the vehicle 106 in FIG. 2 can represent each of the vehicles 106A-C in FIG. 1. The vehicles 104, 106 include controllers 200 that represent hardware circuitry that includes or is connected with one or more processors (e.g., one or more integrated circuits, field programmable gate arrays, microprocessors, or the like) that perform the operations described herein. The vehicles 104, 106 include wireless communication units 202 that represent transceiving hardware (e.g., antennas, modems, codecs, etc.) that wirelessly communicates the signals described herein. The vehicles 104, 106 also include wired communication units 204 that represent transceiving hardware (e.g., modems, codecs, etc.) that communicate the signals described herein via wired connections, such as the intra-consist cables 114.

The controller can use the wired and wireless communication units to communicate the signals described above. In the cable-connected state, the vehicle 104 in each consist can communicate the intra-consist control signals via the intra-consist cable to the vehicle 106 or vehicles 106 in the same consist using the wired communication units. In the non-cable-connected state, the vehicle 104 in each consist can wirelessly communicate the intra-consist control signals to the vehicle 106 or vehicles 106 in the same consist using the wireless communication units. In both the cable-connected state and the non-cable-connected state of the consists or vehicle system, the lead vehicle can wirelessly communicate inter-consist control signals to the controlling remote vehicle using the wireless communication units.

In response to receiving a control signal or based on a received control signal, the controller can direct a propulsion system 206 onboard the corresponding vehicle to generate tractive effort and/or braking effort according to the control signal. The propulsion system can represent one or more engines, alternators, generators, motors, or the like, that operate to propel the vehicle (and vehicle system) and/or brake the vehicle or vehicle system (e.g., using dynamic braking).

The controllers onboard the lead vehicles can switch between the cable-connected state and the non-cable-connected state based on operator input that the intra-consist cable is not available for communication or based on detecting an inability to communicate with a trail vehicle in the same consist via the intra-consist cable. Optionally, the controller can determine whether one or more trail vehicles in the same consist are sending responsive signals to the controller via the intra-consist cable. If a responsive signal is not received, the controller can determine that the intra-consist cable is not available for communication (e.g., due to the cable being taken or broken, or the wired communication unit malfunctioning).

Optionally, the controller can receive information indicating that the intra-consist cable is not available for wired communication from a profile of the vehicle system that stored in an onboard database 208, received from an offboard location (e.g., via the wireless communication unit), or generated by or received from an energy management system 210 (EMS in FIG. 2). The profile can indicate or identify which propulsion-generating vehicles are in the vehicle system and/or in the same consist as the lead vehicle. Based on this information, the lead vehicle can determine which of the vehicles in the same consist are not responding to control signals or other signals sent via the intra-consist cable. These non-responsive vehicles can indicate that the intra-consist cable is no longer available for communication, and the controller can switch to the non-cable-connected state. Optionally, an off-board source (e.g., a security system, a camera, a dispatch system, or the like) may communicate information indicating that a cable is missing or damaged to the controller.

The energy management system represents hardware circuitry that includes or is connected with one or more processors that determine operational settings of the vehicle system. For example, the energy management system can determine throttle settings, speeds, brake settings, accelerations, or the like, for different vehicles 104, 106 at different times, locations, distances, etc. to cause the vehicle system to arrive at a location within a scheduled time but while consuming less fuel, consuming less electric energy, generating less noise, and/or generating fewer emissions when compared to the same vehicle system arriving at the same location within the same scheduled time but using different operational settings. The energy management system may store information or access information on the profile of the vehicle system from the database to determine the operational settings.

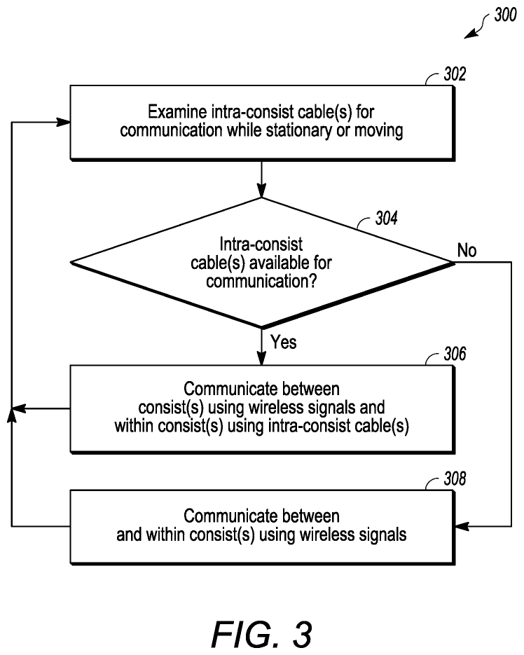

FIG. 3 illustrates a flowchart of one example of a method 300 for controlling movement of a vehicle system. The method can represent operations performed by the control system (and the controller(s)) shown in FIGS. 1 and 2 to control movement of a multi-vehicle system shown in FIG. 1. At step 302, prior to or during travel of the vehicle system, the intra-consist cable(s) are examined for availability to communicate signals. For example, operator input, the absence of responsive signals from one or more vehicles via the cable(s), profile information about the vehicle system, etc., can be used to determine whether a cable has been stolen, not installed, damaged, or the like, or if a wired communication unit has malfunctioned. This can be performed while the vehicle system is stationary (e.g., prior to departure or during travel but while stopped) or while the vehicle system is moving).

At step 304, a determination is made whether one or more of the intra-consist cables are available for communication. If an intra-consist cable is not available for communication due to theft to the cable, damage to the cable, and/or malfunction of a wired communication unit, then the vehicles within that consist may not be able to use wired communication via the cable between or among the vehicles. As a result, the vehicle system and controller(s) may need to switch to a non-cable-connected state and flow of the method can proceed toward step 308. Otherwise, the vehicle system and controller(s) can switch to or remain in a cable-connected state and flow of the method can proceed toward step 306.

The determination of whether the vehicle system is in a cable-connected state or a non-cable connected state may be made on a consist-by-consist basis. One or more consists in a vehicle system may operate in the cable-connected state while one or more other consists in the same vehicle system may concurrently operate in the non-cable-connected state. For example, the MU cable in the first consist may be stolen or damaged while the MU cable in the second consist may be present and operational. The vehicles in the first consist may switch from the cable-connected state to the non-cable-connected state while the vehicles in the second consists remain in the cable-connected state. Alternatively, if any consist switches to the non-cable-connected state, all consists may switch to the non-cable-connected state, regardless of whether the MU cables are present and functional.

At step 306, communications between consists occur wirelessly while communications within consists in the cable-connected state occur via the cable. For example, the lead and controlling remote vehicles wirelessly communicate, while the vehicles within consists in the cable-connected state occur via the intra-consist cable. If one or more of the consists are in the non-cable-connected state, then the vehicles within these consists can communicate wirelessly, as described above and below in connection with 308.

At step 308, communications both between consists and within consists occur wirelessly. For example, the lead and controlling remote vehicles wirelessly communicate, and the vehicles within consists in the non-cable-connected state wirelessly communicate. If one or more of the consists are in the cable-connected state, then the vehicles within these consists can communicate via the intra-consists cable(s) of each consist, as described above. Flow of the method following step 306 and/or step 308 can return toward step 302. Alternatively, flow of the method can terminate.

In an example, the controller may control the wireless communication unit to wirelessly communicate the first vehicle control signals to the second propulsion-generating vehicle and may control the wireless communication unit to wirelessly communicate the different, second vehicle control signals to the third propulsion-generating vehicle at substantially the same time, meaning within a very small time window (<1 sec) such that in light of engine, motor, or braking system response lag times, the second propulsion-generating vehicle and the third propulsion-generating vehicle are controlled effectively simultaneously. In one aspect of such simultaneous control, the first vehicle control signals may control the second propulsion-generating vehicle to a same throttle or braking level as the first propulsion-generating vehicle, and the second vehicle control signals may control the third propulsion-generating vehicle to a different throttle or breaking level than the first and second propulsion-generating vehicles. That is, at least during certain time periods, the second and third propulsion-generating vehicles may be simultaneously controlled to different throttle or breaking levels.

In an example, a vehicle control system includes a controller that may be operably deployed onboard a first propulsion-generating vehicle of a multi-vehicle system, and a wireless communication unit that may be electrically coupled to the controller. The controller may control the wireless communication unit to wirelessly communicate first vehicle control signals to a second propulsion-generating vehicle of the multi-vehicle system that is immediately adjacent and mechanically coupled to the first propulsion-generating vehicle, while the first propulsion-generating vehicle and the second propulsion-generating vehicle are in a non-cable-connected state. The controller may control the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system.

The controller may control the wireless communication unit to wirelessly communicate the first vehicle control signals to the second propulsion-generating vehicle responsive to detecting the non-cable-connected state of a consist that includes the first propulsion-generating vehicle and the second propulsion-generating vehicle. The controller may control the wireless communication unit to wirelessly communicate the first vehicle control signals to the second propulsion-generating vehicle responsive to receiving information indicative of the second propulsion-generating vehicle being or will be immediately adjacent to the first propulsion-generating vehicle. The controller may receive the information from a profile of the multi-vehicle system that is at least one of stored in a database, received from an offboard location, or generated by or received from an energy management system of the first propulsion-generating vehicle. The controller may operate without communicating the first vehicle control signals using the wireless communication unit and to instead communicate the first vehicle control signals to the second propulsion-generating vehicle via an intra-consist cable that interconnects the first propulsion-generating vehicle and the second propulsion-generating vehicle, responsive to the first propulsion-generating vehicle and the second propulsion-generating vehicle being in a cable-connected state.

The first vehicle control signals may be multiple-unit control signals for controlling at least the first propulsion-generating vehicle and the second propulsion-generating vehicle in a lead, first consist, and the second vehicle control signals may be remote control signals for remotely controlling at least the third propulsion-generating vehicle in a remote, second consist. The controller may control the wireless communication unit to wirelessly communicate the first vehicle control signals in a first bandwidth to the second propulsion-generating vehicle of the multi-vehicle system, while the first propulsion-generating vehicle and the second propulsion-generating vehicle are in the non-cable-connected state. The controller may control the wireless communication unit to wirelessly communicate the different, second vehicle control signals in a distinct, second bandwidth to the third propulsion-generating vehicle.

In an example, a method includes controlling a wireless communication unit onboard a first propulsion-generating vehicle to wirelessly communicate first vehicle control signals to a second propulsion-generating vehicle of a multi-vehicle system that is immediately adjacent and mechanically coupled to the first propulsion-generating vehicle, while the first propulsion-generating vehicle and the second propulsion-generating vehicle are in a non-cable-connected state. The method also includes controlling the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system.

The method also can include controlling the wireless communication unit to wirelessly communicate the first vehicle control signals to the second propulsion-generating vehicle responsive to detecting the non-cable-connected state of a consist that includes the first propulsion-generating vehicle and the second propulsion-generating vehicle. The method also may include controlling the wireless communication unit to wirelessly communicate the first vehicle control signals to the second propulsion-generating vehicle responsive to receiving information indicative of the second propulsion-generating vehicle being or will be immediately adjacent to the first propulsion-generating vehicle. The method also may include receiving the information from a profile of the multi-vehicle system that is at least one of stored in a database, received from an offboard location, or generated by or received from an energy management system of the first propulsion-generating vehicle. The method may include operating the first propulsion-generating vehicle without communicating the first vehicle control signals using the wireless communication unit and instead communicating the first vehicle control signals to the second propulsion-generating vehicle via an intra-consist cable that interconnects the first propulsion-generating vehicle and the second propulsion-generating vehicle, responsive to the first propulsion-generating vehicle and the second propulsion-generating vehicle being in a cable-connected state.

The method may include the first vehicle control signals being multiple-unit control signals for controlling at least the first propulsion-generating vehicle and the second propulsion-generating vehicle in a lead, first consist, and the second vehicle control signals being remote control signals for remotely controlling at least the third propulsion-generating vehicle in a remote, second consist. The method may include wirelessly communicating the first vehicle control signals in a first bandwidth to the second propulsion-generating vehicle of the multi-vehicle system, while the first propulsion-generating vehicle and the second propulsion-generating vehicle are in the non-cable-connected state. The method also can include wirelessly communicating the different, second vehicle control signals in a distinct, second bandwidth to the third propulsion-generating vehicle.

In an example, a vehicle control system includes at least one processor that may be operably deployed onboard a first propulsion-generating vehicle of a vehicle system, and a wireless communication unit that may be electrically coupled to the at least one processor. The at least one processor may, responsive to first information that the first propulsion-generating vehicle and a second propulsion-generating vehicle that is immediately adjacent and mechanically coupled to the first propulsion-generating vehicle are in a non-cable-connected state, control the wireless communication unit to wirelessly transmit first vehicle control signals in a first bandwidth to the second propulsion-generating vehicle. Responsive to second information that the first propulsion-generating vehicle and the propulsion-generating vehicle are in a cable-connected state, the at least one processor may control communication of the first vehicle control signals to the second propulsion-generating vehicle over a cable. The at least one processor may control the wireless communication unit to wirelessly transmit different, second vehicle control signals in a distinct, second bandwidth to a third propulsion-generating vehicle of the vehicle system that is separated from the first and second propulsion-generating vehicles by at least one non-propulsion-generating vehicle.

The at least one processor may direct the wireless communication unit to wirelessly transmit one or more of a throttle setting or a brake setting for the second propulsion-generating unit to implement via at least one of the first vehicle control signals, and the at least one processor may direct the wireless communication unit to wirelessly transmit one or more of a tractive effort or a braking effort that a vehicle consist in which the third propulsion-generating vehicle is to generate as at least one of the second vehicle control signals. The first and second propulsion-generating vehicles may be in a first consist, the third propulsion-generating vehicle may be in a second consist, and the first consist and the second consist may be interconnected with each other in a multi-vehicle system by at least the non-propulsion-generating vehicle.

The at least one processor may receive the first information that the first propulsion-generating vehicle and the second propulsion-generating vehicle are in the non-cable-connected state responsive to a multiple unit cable being stolen or damaged. The at least one processor may receive the first information that the first propulsion-generating vehicle and the second propulsion-generating vehicle are in the non-cable-connected state responsive to the wireless communication unit being unable to wirelessly communicate with another device.

The at least one processor may direct the wireless communication unit to wirelessly transmit the second vehicle control signals to the third propulsion-generating vehicle regardless of whether the first and second propulsion-generating vehicles are in the cable-connected state or the non-cable-connected state.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the examples, including the best mode, and to enable a person of ordinary skill in the art to practice the examples, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A vehicle control system comprising:
a controller configured to be operably deployed onboard a first propulsion-generating vehicle of a multi-vehicle system; and
a wireless communication unit configured to be electrically coupled to the controller,
wherein the controller is configured to control the wireless communication unit to wirelessly communicate first vehicle control signals to a second propulsion-generating vehicle of the multi-vehicle system that is immediately adjacent and mechanically coupled to the first propulsion-generating vehicle, while the first propulsion-generating vehicle and the second propulsion-generating vehicle are in a non-cable-connected state; and
wherein the controller is configured to control the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system,
wherein the first vehicle control signals are multiple-unit control signals for controlling at least the first propulsion-generating vehicle and the second propulsion-generating vehicle in a lead, first consist, and the second vehicle control signals are remote control signals for remotely controlling at least the third propulsion-generating vehicle in a remote, second consist.

2. The system of claim 1, wherein the controller is configured to control the wireless communication unit to wirelessly communicate the first vehicle control signals to the second propulsion-generating vehicle responsive to detecting the non-cable-connected state of the lead, first consist that includes the first propulsion-generating vehicle and the second propulsion-generating vehicle.

3. The system of claim 1, wherein the controller is configured to control the wireless communication unit to wirelessly communicate the first vehicle control signals to the second propulsion-generating vehicle responsive to receiving information indicative of the second propulsion-generating vehicle being or will be immediately adjacent to the first propulsion-generating vehicle.

4. The system of claim 3, wherein the controller is configured to receive the information from a profile of the multi-vehicle system that is at least one of stored in a database, received from an offboard location, or generated by or received from an energy management system of the first propulsion-generating vehicle.

5. The system of claim 1, wherein the controller is further configured to operate without communicating the first vehicle control signals using the wireless communication unit and to instead communicate the first vehicle control signals to the second propulsion-generating vehicle via an intra-consist cable that interconnects the first propulsion-generating vehicle and the second propulsion-generating vehicle, responsive to the first propulsion-generating vehicle and the second propulsion-generating vehicle being in a cable-connected state.

6. The system of claim 1, wherein the first vehicle control signals direct first vehicles in the lead, first consist that include at least the first propulsion-generating vehicle and the second propulsion-generating vehicle in an identical manner while the second vehicle control signals direct at least the third propulsion-generating vehicle in the remote, second consist in a different manner.

7. The system of claim 1, wherein the controller is configured to control the wireless communication unit to wirelessly communicate the first vehicle control signals in a first bandwidth to the second propulsion-generating vehicle of the multi-vehicle system, while the first propulsion-generating vehicle and the second propulsion-generating vehicle are in the non-cable-connected state; and
wherein the controller is configured to control the wireless communication unit to wirelessly communicate the different, second vehicle control signals in a distinct, second bandwidth to the third propulsion-generating vehicle.

8. A method comprising:
controlling a wireless communication unit onboard a first propulsion-generating vehicle to wirelessly communicate first vehicle control signals to a second propulsion-generating vehicle of a multi-vehicle system that is immediately adjacent and mechanically coupled to the first propulsion-generating vehicle, while the first propulsion-generating vehicle and the second propulsion-generating vehicle are in a non-cable-connected state; and
controlling the wireless communication unit to wirelessly communicate different, second vehicle control signals to a third propulsion-generating vehicle of the multi-vehicle system that is separated from the first and second propulsion-generating vehicles by at least one non-propulsion-generating vehicle in the multi-vehicle system.

9. The method of claim 8, further comprising controlling the wireless communication unit to wirelessly communicate the first vehicle control signals to the second propulsion-generating vehicle responsive to detecting the non-cable-connected state of a consist that includes the first propulsion-generating vehicle and the second propulsion-generating vehicle.

10. The method of claim 8, further comprising controlling the wireless communication unit to wirelessly communicate the first vehicle control signals to the second propulsion-generating vehicle responsive to receiving information indicative of the second propulsion-generating vehicle being or will be immediately adjacent to the first propulsion-generating vehicle.

11. The method of claim 10, further comprising receiving the information from a profile of the multi-vehicle system that is at least one of stored in a database, received from an offboard location, or generated by or received from an energy management system of the first propulsion-generating vehicle.

12. The method of claim 8, further comprising operating the first propulsion-generating vehicle without communicating the first vehicle control signals using the wireless communication unit and instead communicating the first vehicle control signals to the second propulsion-generating vehicle via an intra-consist cable that interconnects the first propulsion-generating vehicle and the second propulsion-generating vehicle, responsive to the first propulsion-generating vehicle and the second propulsion-generating vehicle being in a cable-connected state.

13. The method of claim 8, wherein the first vehicle control signals are multiple-unit control signals for controlling at least the first propulsion-generating vehicle and the second propulsion-generating vehicle in a lead, first consist, and the second vehicle control signals are remote control signals for remotely controlling at least the third propulsion-generating vehicle in a remote, second consist.

14. The method of claim 8, further comprising:
wirelessly communicating the first vehicle control signals in a first bandwidth to the second propulsion-generating vehicle of the multi-vehicle system, while the first propulsion-generating vehicle and the second propulsion-generating vehicle are in the non-cable-connected state; and
wirelessly communicating the different, second vehicle control signals in a distinct, second bandwidth to the third propulsion-generating vehicle.

15. A vehicle control system comprising:
at least one processor configured to be operably deployed onboard a first propulsion-generating vehicle of a vehicle system; and
a wireless communication unit configured to be electrically coupled to the at least one processor,
wherein the at least one processor is configured, responsive to first information that the first propulsion-generating vehicle and a second propulsion-generating vehicle that is immediately adjacent and mechanically coupled to the first propulsion-generating vehicle are in a non-cable-connected state, to control the wireless communication unit to wirelessly transmit first vehicle control signals in a first bandwidth to the second propulsion-generating vehicle, and, responsive to second information that the first propulsion-generating vehicle and the propulsion-generating vehicle are in a cable-connected state, to control communication of the first vehicle control signals to the second propulsion-generating vehicle over a cable; and
wherein the at least one processor is configured to control the wireless communication unit to wirelessly transmit different, second vehicle control signals in a distinct, second bandwidth to a third propulsion-generating vehicle of the vehicle system that is separated from the first and second propulsion-generating vehicles by at least one non-propulsion-generating vehicle.

16. The control system of claim 15, wherein the at least one processor is configured to direct the wireless communication unit to wirelessly transmit one or more of a throttle setting or a brake setting for the second propulsion-generating unit to implement via at least one of the first vehicle control signals, and the at least one processor is configured to direct the wireless communication unit to wirelessly transmit one or more of a tractive effort or a braking effort that a vehicle consist in which the third propulsion-generating vehicle is to generate as at least one of the second vehicle control signals.

17. The control system of claim 15, wherein the first and second propulsion-generating vehicles are in a first consist, the third propulsion-generating vehicle is in a second consist, and the first consist and the second consist are interconnected with each other in a multi-vehicle system by at least the non-propulsion-generating vehicle.

18. The control system of claim 15, wherein the at least one processor is configured to receive the first information that the first propulsion-generating vehicle and the second propulsion-generating vehicle are in the non-cable-connected state responsive to a multiple unit cable being stolen or damaged.

19. The control system of claim 15, wherein the at least one processor is configured to receive the first information that the first propulsion-generating vehicle and the second propulsion-generating vehicle are in the non-cable-connected state responsive to the wireless communication unit being unable to wirelessly communicate with another device.

20. The control system of claim 15, wherein the at least one processor is configured to direct the wireless communication unit to wirelessly transmit the second vehicle control signals to the third propulsion-generating vehicle regardless of whether the first and second propulsion-generating vehicles are in the cable-connected state or the non-cable-connected state.
